(19) United States
(12) Patent Application Publication
(10) Pub. No.: US 2018/0078433 A1
(43) Pub. Date: Mar. 22, 2018

(54) Mechanical Lift Seat for Use with Transportation Assistance Devices and/or On Any Stationary Horizontal Surface

(71) Applicant: Frank P. Suess, Wellington, FL (US)

(72) Inventor: Frank P. Suess, Wellington, FL (US)

(73) Assignee: Frank P. Suess, Wellington, FL (US)

(21) Appl. No.: 15/506,412

(22) PCT Filed: Aug. 21, 2015
(86) PCT No.: PCT/US15/46220

§ 371 Date: Feb. 24, 2017

Related U.S. Application Data
(60) Provisional application No. 62/041,224, filed on Aug. 25, 2014.

(51) Int. Cl. A61G 5/14; A61G 5/10; A61H 3/04

(52) U.S. Cl. CPC A61G 5/14; A61H 3/04; A61G 5/1045

(57) ABSTRACT

A mechanical lift seat for use with transportation assistance devices and/or on any stationary horizontal surface is disclosed. The mechanical lift seat is designed for assisting a person into a seated position or into a standing position. The mechanical lift 5 seat includes an upper shell and a lower shell that are hingeably coupled using a hinge. The opening and closing of the upper shell and the lower shell is controlled, for example, using a pneumatic piston or a spring device. Further, the mechanical lift seat can include fastening devices for engaging with the horizontal rails or bars of transportation assistance devices, such as wheelchairs, transport chairs, companion chairs, walkers, and 10 the like.

### CROSS-REFERENCE TO RELATED APPLICATIONS

The presently disclosed subject matter is related to and claims priority to U.S. Provisional Patent Application No. 62/041,224 entitled “Mechanical Lift Seat for Use with Transportation Assistance Devices and/or On Any Stationary Horizontal Surface” filed on Aug. 25, 2014; the entire disclosure of which is incorporated herein by reference.

### TECHNICAL FIELD

The presently disclosed subject matter relates generally to lift assist devices and more particularly to a mechanical lift seat for use with transportation assistance devices and/or on any stationary horizontal surface.

### BACKGROUND

Persons with infirmities, such as those caused by age, illness, surgery, joint replacements, and other medical conditions, may need assistance to come from a seated position to a standing position or from a standing position to a seated position. For example, lift seat devices exist today that are designed for use with a stationary horizontal surface, such as a chair, couch, car seat, bench, and the like. However, these lift seat devices are not suitable for use with transportation assistance devices, such as wheelchairs, transport chairs, companion chairs, walkers, and the like.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a perspective view of an example of the presently disclosed mechanical lift seat; and

FIG. 2 illustrates a perspective view of the presently disclosed mechanical lift seat when in use with a wheelchair.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The presently disclosed subject matter is a mechanical lift seat for use with transportation assistance devices and/or on any stationary horizontal surface. In some embodiments, the mechanical lift seat is designed for assisting a person into a seated position or into a standing position. The mechanical lift seat may be used with any two bar transportation assistance device as well as any stationary horizontal surface. For example, the mechanical lift seat may be designed and shaped to be fitted onto various types of transportation assistance devices, such as, but not limited to, wheelchairs, walkers, and the like, some of which may include folding mechanisms.

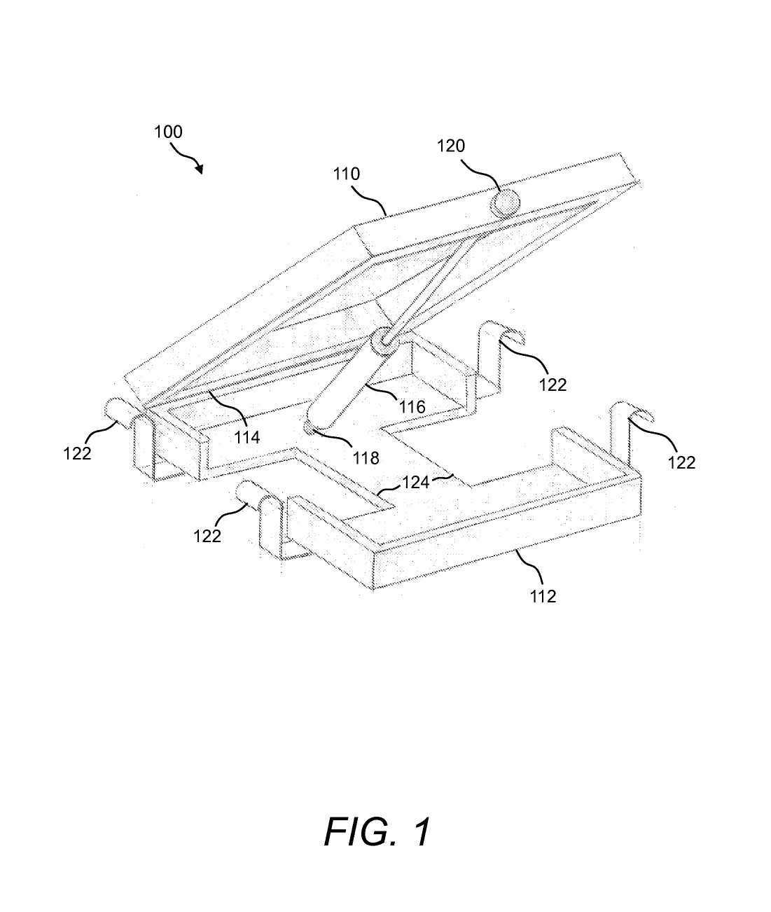

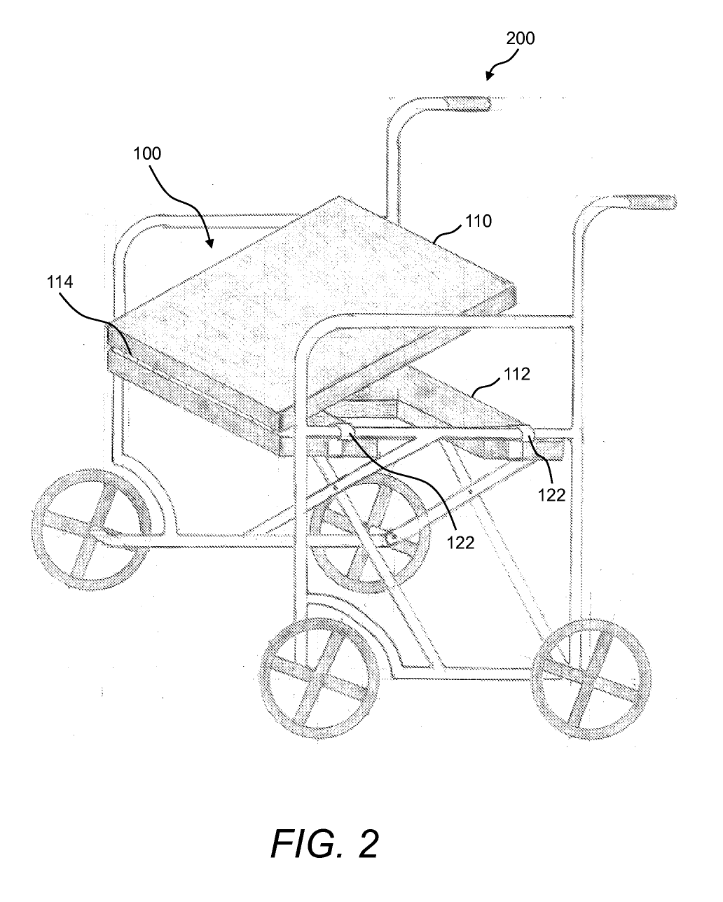

FIG. 1 illustrates a perspective view of an example of a mechanical lift seat 100. The mechanical lift seat 100 may be used with any two bar transportation assistance device as well as any stationary horizontal surface. In preferred embodiments, the mechanical lift seat 100 may be used to replace the seat of a transportation assistance device, such as a wheelchair or walker. By way of example, FIG. 2 shows the presently disclosed mechanical lift seat 100 when in use with a wheelchair 200, wherein the wheelchair 200 is one example of a transportation assistance device.

In some embodiments, the mechanical lift seat 100 may include an upper shell 110 and a lower shell 112 that are hingeably coupled using a hinge 114. The upper shell 110 and the lower shell 112 may be formed of any rigid, lightweight material that is suitably strong for sitting on, such as, but not limited to, wood, wood composite, metal (e.g., aluminum), fiber glass, and/or plastic. In one example, the upper shell 110 and the lower shell 112 are about 18 inches wide by about 18 inches long, as dictated by the most common wheelchair dimensions. Further, the upper shell 110 may be covered with any material suitable for comfortable sitting (not shown), such as foam, rubber, any type of fabric or upholstery, or the like. In certain embodiments, the covering of the upper shell 110 may be removable and washable, or simply replaceable.

Together, the upper shell 110, the lower shell 112, and the hinge 114 may form a clamshell type of assembly that is, for example, about 5 inches thick. The opening and closing of the upper shell 110 and the lower shell 112 may be controlled, for example, by a pneumatic piston 116. In another example, a spring device (not shown) may be used to control the opening and closing of the upper shell 110 and the lower shell 112. In some embodiments, the force or tension of the pneumatic piston 116 or the spring device (not shown) may be adjusted according to certain characteristics of the user, such as, for example, the user's weight. In certain other embodiments, the force or tension of the pneumatic piston 116 or the spring device (not shown) may be fixed. In one example, the force provided by the pneumatic piston 116 or the spring device (not shown) can be adjusted to lift patients with a weight between 90-250 pounds to a standing position. Further still, other embodiments of the mechanical lift seat 100 may include more than one pneumatic piston or spring device, or a combination of both one or more pneumatic pistons and one or more spring devices to lift patients with a weight between 200-300 pounds to a standing position.

In the example shown in FIG. 1, the cylinder-end of the pneumatic piston 116 is attached to the lower shell 112 using a pivot connection 118. The rod-end of the pneumatic piston 116 is attached to the upper shell 110 using a fastener 120. Namely, the rod-end of the pneumatic piston 116 is attached to the edge of the upper shell 110 that is opposite the hinge 114. In one example, the rod-end of the pneumatic piston 116 may be threaded and fastened to the edge of the upper shell 110 with a nut or threaded cap 120. In another example, the cylinder-end of the pneumatic piston 116 may be attached to the upper shell 110 and the rod-end of the pneumatic piston 116 is attached to the lower shell 112.

The mechanical lift seat 100 may be used with any two bar transportation assistance device as well as any stationary horizontal surface. In some embodiments, the operation of the mechanical lift seat 100 is as follows. When no one is sitting on the mechanical lift seat 100 there is no force (or weight) upon the upper shell 110. Therefore, the force of the pneumatic piston 116 may push the upper shell 110 away from the lower shell 112. This is considered the open state of mechanical lift seat 100. Then, with the mechanical lift seat 100 in the open state, a person may begin to sit on the upper shell 110. The weight of the person overcomes the force of the pneumatic piston 116 and the upper shell 110 closes down onto the lower shell 112. All the while, the pneumatic piston 116 may be configured to provide gentle resistance as the upper shell 110 settles onto the lower shell 112, thereby gently lowering the person into a fully seated position on the mechanical lift seat 100. This is considered the closed state of mechanical lift seat 100.

Subsequently, a person seated on the mechanical lift seat 100 in the closed position may decide to stand up. In so doing, the person begins to lift his/her weight off of the mechanical lift seat 100. Consequently, the force of the pneumatic piston 116 pushes the upper shell 110 away from the lower shell 112 and the upper shell 110 may provide a gentle upward force to the person's body, thereby assisting the person to the standing position. In this way, the mechanical lift seat 100 may be used to gently raise the person into a fully standing position.

The mechanical lift seat 100 may include any types of fastening devices needed depending on the type of transportation assistance device with which it is used. By way of just one of many examples, FIG. 1 and FIG. 2 show fastening devices 122 attached to the sides of the lower shell 112 that may be configured for mating the mechanical lift seat 100 to the wheelchair 200. In this example, fastening devices 122 are metal hooking members that engage with the horizontal rails or bars of the wheelchair 200. Namely, the sling seat of the wheelchair may be removed and then the mechanical lift seat 100 may be fitted into the wheelchair 200, wherein the fastening devices 122 are engaged with the horizontal rails or bars of the wheelchair 200. In certain other embodiments, the fastening devices 122 may be of any other configuration (e.g. snapping mechanisms) to facilitate installation of the mechanical lift seat 100 to a transportation assistance device or other mechanism. The fastening devices 122 may be adjustable (e.g., may be configured to slide in and out with respect to the lower shell 112). Further, the fastening devices 122 may be removable to accommodate use outside of a transportation assistance device, such as on a flat horizontal surface (i.e. bench or chair).

Further, the mechanical lift seat 100 may include any other features necessary for mating to a particular type of transportation assistance device. For example, the mechanical lift seat 100 shown in FIG. 1 and FIG. 2 includes a pair of cutout regions 124. In this example, the cutout regions 124 provide clearance for any other hardware of the wheelchair 200, such as folding mechanisms.

The mechanical lift seat 100 may be used with any two bar transportation assistance device as well as any stationary horizontal surface. In one example shown with reference to FIG. 2, the mechanical lift seat 100 is installed into the wheelchair 200. A person is assisted by the mechanical lift seat 100 into a seated position in the wheelchair 200. The person is then transported in the wheelchair 200 to, for example, a dining room. Then, using the mechanical lift seat 100 in the wheelchair 200, the person is assisted to a standing position. Then, the person or another person quickly and easily removes the mechanical lift seat 100 from the wheelchair 200 and places the mechanical lift seat 100 onto the seat of a dining room chair. Then, assisted by the mechanical lift seat 100, the person sits on the dining room chair. When finished eating, using the mechanical lift seat 100 in the dining room chair, the person is assisted to a standing position. Then, the mechanical lift seat 100 is quickly and easily returned to the wheelchair 200 and used to assist the person to the seated position in the wheelchair 200. The foregoing is just one of many examples where the mechanical lift seat 100 may be used to assist a person in sitting and/or standing in relation to a transportation device (e.g. wheelchair 200) and a stationary horizontal surface, thereby giving a user greater mobility.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A mechanical lift seat comprising:
a. an upper shell and a lower shell, wherein the upper and lower shells are coupled together along a front side in a clamshell configuration using a hinge mechanism;
b. an opening mechanism having a first end and a second end, wherein the first end of the opening mechanism is coupled to the lower shell and the second end of the opening mechanism is coupled to the upper shell; and
c. one or more fastening devices configured to removably couple the mechanical lift seat to a transportation assistance device.

2. The lift seat of claim 1 wherein the opening mechanism provides a fixed force.

3. The lift seat of claim 1 wherein the opening mechanism provides an adjustable force according to characteristics of the user.

4. The lift seat of claim 3 wherein the characteristics of the user comprise the user's weight.

5. The lift seat of claim 1 wherein the opening mechanism comprises one or more pneumatic pistons.

6. The lift seat of claim 1 wherein the opening mechanism comprises one or more springs.

7. The lift seat of claim 1 wherein the opening mechanism comprises one or more pneumatic pistons and one or more springs.

8. The lift seat of claim 1 wherein the upper shell comprises a covering.

9. The lift seat of claim 8 wherein the covering is comprised of one or more of foam, rubber, or upholstery.

10. The lift seat of claim 8 wherein the covering is removable.

11. The lift seat of claim 10 wherein the covering is washable.

12. The lift seat of claim 1 wherein the upper and lower shells are formed from one or more of wood, metal, fiber glass, or plastic.

13. The lift seat of claim 1 wherein the lower shell comprises cut-out regions.

14. The lift seat of claim 1 wherein the one or more fastening devices are adjustable to accommodate installation of the lift seat in transportation assistance devices of various widths and lengths.

15. The lift seat of claim 1 wherein the fastening devices comprise metal hooking members.

16. The lift seat of claim 1 wherein the opening mechanism is configured to maintain the seat in an open state when no user is seated thereon.

17. The lift seat of claim 1 wherein the opening mechanism is configured to allow the upper portion to pivot relative to the lower portion about the hinge mechanism at a controlled rate when a user positions themselves thereon.

18. The lift seat of claim 1 wherein the lift seat replaces a seat of the transportation assistance device.

19. The lift seat of claim 1 wherein the transportation assistance device comprises a two bar transportation assistance device.

20. The lift seat of claim 1 wherein the transportation assistance device is one of a wheelchair, a walker, or a chair.

21. The lift seat of claim 1 wherein when the lift seat is removed from the transportation assistance device, the lift seat is configured to couple to a stationary horizontal surface.

22. A transportation assistance device comprising a removable mechanical lift seat, the mechanical lift seat comprising:
a. an upper shell and a lower shell, wherein the upper and lower shells are coupled together along a front side in a clamshell configuration using a hinge mechanism;
b. an opening mechanism having a first end and a second end, wherein the first end of the opening mechanism is coupled to the lower shell and the second end of the opening mechanism is coupled to the upper shell; and
c. one or more fastening devices configured to removably couple the mechanical lift seat to a transportation assistance device.
